(19) United States
(12) Patent Application Publication
(10) Pub. No.: US 2022/0411288 A1
(43) Pub. Date: Dec. 29, 2022

(54) REMOVING CONTAMINANTS FROM LIQUIDS

(71) Applicant: SEACHANGE TECHNOLOGIES, INC., RALEIGH, NC (US)

(72) Inventor: Dipak Mahato, Raleigh, NC (US)

(73) Assignee: SEACHANGE TECHNOLOGIES, INC., RALEIGH, NC (US)

(21) Appl. No.: 17/780,752

(22) PCT Filed: Nov. 9, 2020
(86) PCT No.: PCT/US2020/059603

§ 371 Date: May 27, 2022

Related U.S. Application Data
(60) Provisional application No. 62/944,156, filed on Dec. 5, 2019.

(51) Int. Cl. C02F 1/02; C02F 1/72; C02F 1/00

(52) U.S. Cl. CPC C02F 1/02; C02F 1/72; C02F 1/008; C02F 2209/02; C02F 2103/30

(57) ABSTRACT

Contaminants can be removed from liquids in accordance with systems and methods herein. One exemplary method can involve introducing an input liquid into a pressurized chamber. The method can also involve oxidizing an organic or inorganic contaminant in the input liquid by heating the input liquid in the pressurized chamber, to create an output liquid that has less of the organic or inorganic contaminant than is present in the input liquid. And the method can involve outputting the output liquid from the pressurized chamber.

### CROSS REFERENCE TO RELATED APPLICATION

This application claims priority to U.S. Application No. 62/944,156 filed on Dec. 5, 2019, and entitled “Removing Contaminants From Liquids,” the entirety of which is incorporated herein by reference.

### TECHNICAL FIELD

The present disclosure relates to treatment of liquids. More specifically, but not by way of limitation, the present invention relates to removing contaminants from liquids.

### BACKGROUND

Natural liquids (e.g., water from rivers, lakes, underground reservoirs, rain, and oceans) or human-produced liquids (e.g., residential or municipal sewage, industrial effluent, and manufacturing byproduct) may contain contaminants that make the liquid unfit for human or industrial use. Examples of such contaminants can include oil and grease, volatile organics, dissolved solids, and suspended solids. Removal or destruction of contaminants may allow for beneficial use of that liquid.

There are a variety of liquid-treatment processes for removing or destroying contaminants. But typical liquid-treatment processes involve hazardous chemicals or expensive membranes. Typical liquid-treatment processes must also be customized for the particular application at hand. Each type of contaminant has unique physical and chemical properties from the other types, such that each contaminant type requires a different liquid-treatment process to separate the contaminant from the underlying liquid or to destroy it. As a result, the treatment process for a particular liquid must be tailored towards the type of contaminant to be removed or destroyed, the desired use of the resulting decontaminated liquid, cost/energy constraints, environmental impact, and byproduct disposal options.

The waste byproducts from typical liquid-treatment processes are particularly problematic. These waste byproducts are often environmentally hazardous and their disposal is expensive. For example, a waste byproduct of biological and chemical treatment of volatile organics is typically large amounts of sludge, and the waste byproduct from filtering (e.g., reverse osmosis or membrane) treatments for removing dissolved solids (e.g., salt) is typically a brine concentrate. Byproducts like sludge and brine concentrate are environmentally damaging, with risks including chemical leaching and greenhouse gas emissions.

What is needed are environmentally friendly, efficient, and cost-effective approaches for removing contaminants from liquids.

### SUMMARY

One example of the present disclosure includes a method. The method can include introducing an input liquid into a pressurized chamber. The method can also include oxidizing an organic or inorganic contaminant in the input liquid by heating the input liquid in the pressurized chamber, to create an output liquid that has less of the organic or inorganic contaminant present than the input liquid. The method can include outputting the output liquid from the pressurized chamber.

Another example of the present disclosure includes a system. The system can include a chamber and a pressurizer coupled to the chamber. The pressurizer can be configured to pressurize the chamber to a predefined pressure level. The system can also include a heating device coupled to the chamber, where the heating device is configured to apply heat to the chamber. The system can apply the heat from the heating device to an input liquid in the chamber while the chamber is pressurized to the predefined pressure level, to thereby oxidize an organic or inorganic contaminant in the input liquid and create an output liquid that has less of the organic or inorganic contaminant present than the input liquid.

These illustrative examples are mentioned not to limit or define the limits of the present subject matter, but to aid understanding thereof. Illustrative examples are discussed in the Detailed Description, and further description is provided there. Advantages offered by various examples may be further understood by examining this specification and/or by practicing one or more examples described herein.

### BRIEF DESCRIPTION OF THE FIGURES

A full and enabling disclosure is set forth more particularly in the remainder of the specification. The specification makes reference to the following appended figures.

FIG. 1 is a block diagram of an example of a system for removing contaminants from liquids according to some aspects of the present disclosure.

FIG. 2 is a flow chart of an example of a process for removing contaminants from liquids according to some aspects of the present disclosure.

### DETAILED DESCRIPTION

The following description recites various aspects and examples, but are intended to be non-limiting. The description is to be read from the perspective of one of ordinary skill in the art; therefore, information well-known to the skilled artisan may not necessarily be included.

### Definitions and Abbreviations

The following terms, unless otherwise indicated, shall be understood to have the following meanings:

As used herein, the terms “a,” “an,” and “the” can refer to one or more unless specifically noted otherwise.

The term “or” is not to be construed as identifying mutually exclusive options. For example, the phrase “X contains A or B” can mean that X contains A and not B, X contains B and not A, or X contains both A and B. That is, the term “or” is used to mean “and/or” unless explicitly indicated to refer to alternatives only or the alternatives are mutually exclusive, although the disclosure may support a definition that refers to only alternatives and “and/or.” As used herein “another” can mean at least a second or more.

“Aerosol” as used herein refers to a colloid of fine liquid droplets in a gas (e.g., air).

“Aerosolization component” as used herein refers to a component operable to generate an aerosol from a liquid.

“Contaminants” as used herein refers to any substance or particles that are undesirable for a particular application. For example, contaminants may render a liquid in which the contaminants are dissolved, suspended, or otherwise intermixed unsuitable for a particular place or purpose.

“Contaminated liquid” as used herein refers to a liquid comprising at least one type of contaminant in an amount above a particular threshold. For example, a contaminated liquid may include water in which one or more types of pollutants are dissolved, suspended, or otherwise intermixed in an amount above a threshold suitable for human consumption.

“Separation component” as used herein refers to a device configured to separate at least one type of contaminant from a gas or vapor.

“Vapor” as used herein refers to a substance that is in a gaseous state.

“Vaporize” as used herein refers to the process of generating a vapor from a liquid or aerosol.

### Illustrative Examples

Certain aspects and features of the present disclosure involve a liquid-treatment process that can remove organic and inorganic contaminants from an input liquid. The organic and inorganic contaminants can be removed by performing hydroxyl-radical mediated oxidation of the organic and inorganic contaminants in a pressurized chamber, with the hydroxyl radical being derived from thermally-induced liquid ionization (e.g., ionization of the input liquid by applying heat to the input liquid). This can yield an output liquid that has been “purified” of the organic and inorganic contaminants, in the sense that the output liquid has less of the organic and inorganic contaminants than the input liquid, and ideally less than a predefined threshold amount of the organic and inorganic contaminants.

In some examples, the initial heat required for thermal ionization of the input liquid may be supplied from a heating device. Once oxidation of the organic and inorganic contaminants has begun, additional heat may be released as a result of oxidizing these contaminants. In certain cases, a thermal controller can monitor a temperature in the pressurized chamber and adjust the amount of thermal energy being emitted by the heating device based on the temperature, e.g., to compensate for the additional heat release resulting from the oxidation. This can enable the thermal controller to maintain the pressurized chamber within a target temperature range and improve the energy efficiency of the liquid-treatment process.

In some examples, the output liquid from the oxidation process may be subject to further treatment in to remove particulate (e.g., dissolved or suspended) contaminants. For example, the output liquid from this first liquid-treatment above may serve as an input liquid to a second liquid-treatment process. In the second liquid-treatment process, the input liquid may be converted to aerosol droplets and then transmitted into a low-pressure airflow that vaporizes the aerosol droplets. The resulting airstream can carry a combination of liquid vapor and particulate contaminants. The airstream can then be transmitted to a separation component (e.g., a cyclonic separator) to remove the particulate contaminants, and can be condensed back into liquid form by a condenser. This can yield another output liquid that has been “purified” of the particulate contaminants, in the sense that it has less of the particulate contaminants than the input liquid, and ideally less than a predefined threshold amount of the particulate contaminants.

The description of the illustrative example above is provided merely as an example, not to limit or define the limits of the present subject matter. Various other examples are described herein and variations of such examples would be understood by one of skill in the art. Advantages offered by various examples may be further understood by examining this specification and/or by practicing one or more examples of the claimed subject matter.

### Systems and Methods for Contaminant Removal for Liquids

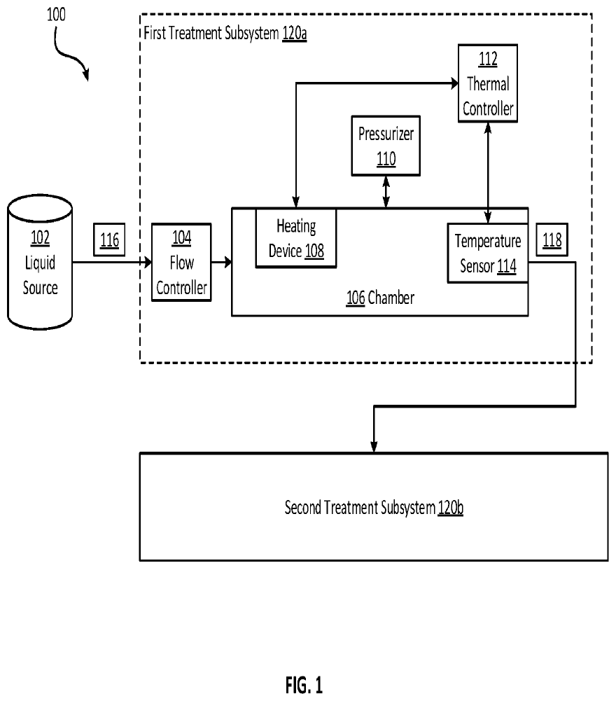

FIG. 1 is a block diagram of an example of a system 100 for removing contaminants from liquids according to some aspects. The system 100 includes a liquid source 102 containing a contaminated liquid 116, which is also be referred to herein as an “input liquid” (since the contaminated liquid is an input to the one or more liquid-treatment processes performed by the system 100). Examples of the contaminated liquid can include textile-production wastewater or hydrocarbon-production wastewater. The liquid source 102 can be a natural source of the contaminated liquid (e.g., a river, lake, or underground reservoir) or a tank housing the contaminated liquid.

The liquid source 102 is coupled to a flow controller 104 configured to control a flow rate at which a contaminated liquid 116 from the liquid source 102 is communicated into a chamber 106 of a first treatment subsystem 120a. Examples of the flow controller 104 can include a pump or an orifice sized to yield a particular flow rate. The flow controller 140 can introduce the contaminated liquid 116 into the chamber 106 in batches or in a continuous flow at a predefined rate (e.g., batch rate or flow rate). For example, the flow controller 140 can communicate the contaminated liquid 116 into the chamber 106 at a predefined flow rate of between 1 gallon per minute (gpm) and 10 gpm.

The chamber 106 can be made of any suitable material, such as metal or plastic. The chamber 106 can be configured to receive the contaminated liquid 116 from the liquid source 102 and perform a first liquid-treatment process on the contaminated liquid 116. For example, a pressurizer 110 (e.g., a pressure pump) coupled to the chamber 106 can pressurize the chamber 106 to a predefined pressure level as part of the liquid-treatment process. The chamber 106 can be pressurized to at least 1500 pounds-per-square-inch (psi), though it may be desirable to maintain the pressure level in the chamber 106 to between 2000 psi and 4000 psi to prevent the contaminated liquid 116 from vaporizing (e.g., to prevent water in the contaminated liquid 116 from vaporizing).

With the chamber 106 pressurized, a heating device 108 coupled to the chamber 106 can apply heat to the contaminated liquid 116 in the chamber 106. Examples of the heating device can include a burner of gas, kerosene, wood, or any other fuel; a resistive heating element; a heat exchanger; a solar powered heater; or any combination of these. The heating device 108 is configured to heat the contaminated liquid 116 to a predefined temperature or within a predefined temperature range. For example, the heating device 108 can heat the contaminated liquid 116 to at least 200° Celsius (C), though it may be desirable to maintain the temperature level below 374° C., which is the critical temperature for water. The contaminated liquid 116 may be heated while in the chamber 106 using only the heating device 108 (without the aid of another heat source that is external to the contaminated liquid 116), or may be heated while in the chamber 106 by the heating device 108 in conjunction with another heat source that is external to the contaminated liquid 116.

Heating the contaminated liquid 116 under these pressurized conditions can cause the contaminated liquid 116 to undergo thermal ionization, which in turn can increase a concentration of hydroxyl radicals in the contaminated liquid 116. The hydroxyl radicals can chemically react with organic and inorganic contaminants in the contaminated liquid 116 to oxidize the organic and inorganic contaminants. This oxidation may occur solely as a result of the heat from the heating device 108, and without introducing a separate oxidizing agent (e.g., an oxidizing gas or chemical agent) into the chamber 106 or catalyst (e.g., metal oxide or a noble metal). This oxidation process is also flameless and can be induced without first separating the contaminated liquid 116 into vapor and liquid phases, thereby reducing the time and energy required for the oxidation process. In some examples, oxidation of the organic and inorganic contaminants produces additional heat that can facilitate additional oxidation, such that the process is at least partially self-perpetuating.

In some examples, this additional heat from the oxidation process can raise the temperature of the contaminated liquid 116 in the chamber 106. Since it may be desirable to maintain the temperature of the contaminated liquid 116 within a preset temperature range (e.g., above a lower temperature threshold and/or below an upper temperature threshold), some examples can include a temperature control system coupled to the heating device 108.

The temperature control system can include a temperature sensor 114 and a thermal controller 112. The temperature sensor 114 can be positioned in any suitable location for detecting a temperature of the contaminated liquid 116 in the chamber 106 or the output liquid 118 from the chamber. The temperature sensor 114 can transmit a sensor signal indicating the temperature to the thermal controller 112. The thermal controller 112 can include a processor (e.g., FPGA, ASIC, or microprocessor) and a non-transitory computer-readable medium with program code that is executable by the processor to perform various operations described herein based on the sensor signal. For example, the thermal controller 112 can receive the sensor signal from the temperature sensor and adjust a thermal output of the heating device 108 based on the sensor signal. For example, the thermal controller 112 can transmit one or more control signals to the heating device 108, where the control signals are configured to cause the heating device 108 to adjust (e.g., raise or lower) its thermal output. The thermal controller 112 can adjust the thermal output of the heating device 108 to offset the additional heat generated as a result of oxidizing the organic and inorganic contaminants, for example, to thereby maintain the temperature of the contaminated liquid 116 in the chamber 106 or the output liquid 118 within the preset temperature range. In some examples, the thermal controller 112 can include artificially intelligent (AI) software in some examples for adjusting the thermal output of the heating device 108 based on sensor signals from the temperature sensor 114.

The result of the above oxidation process can be an output liquid 118 and a gaseous byproduct (not shown in FIG. 1). The output liquid 118 can have less of the organic and inorganic contaminants than the contaminated liquid 116, and ideally less of the organic and inorganic contaminants than is acceptable for a target application. The gaseous byproduct may be carbon monoxide (CO₂) in some examples. The gaseous byproduct may be safely released into the environment, unlike liquid byproducts like sludge or brine concentrate. Alternatively, the gaseous byproduct can be stored for proper disposal and/or another industrial application.

In some examples, the output liquid 118 can be provided as input to a second treatment subsystem 120b configured to implement a second liquid-treatment process. The second liquid-treatment process can remove a particulate contaminant from the output liquid 118 to generate a second output liquid that has less of the particulate contaminant than the output liquid 118. The second liquid-treatment process may remove the particulate contaminant without the use of membranes, filters, resins, or absorption matrices. And the second liquid-treatment process may also not produce a liquid byproduct.

One example of the second treatment subsystem 120b is described in U.S. Pat. No. 9,751,026 to Mahato, which is incorporated by reference in its entirety herein. In such an example, the second treatment subsystem 120b can include an aerosolization component configured to convert the output liquid 118 into an aerosol. The second treatment subsystem 120b can also include a negative pressure source configured to vaporize the aerosol to generate a vapor. The second treatment subsystem 120b can further include a separation component configured to separate the particulate contaminant from the vapor for generating a purified vapor. The second treatment subsystem 120b may also include a condenser configured to convert the purified vapor into the second output liquid. Of course, other examples may involve more, fewer, or a different arrangement of the above components.

While FIG. 1 depicts various components (e.g., the heating device, temperature sensor 114, pressurizer 110, etc.) in certain locations, this is intended to be exemplary and non-limiting. In other example, these components can be positioned in different locations and configurations within the system 100. For example, the pressurizer 110 can be positioned within the chamber 106 and the temperature sensor 114 can be positioned outside the chamber 106.

Additionally, while FIG. 1 depicts the contaminated liquid 116 as first going through the first treatment subsystem 120a and then going through the second treatment subsystem 120b, in other examples this process can be reversed such that the contaminated liquid 116 first goes through the second treatment subsystem 120b and then goes through the first treatment subsystem 120a. Thus, the terms “first” and “second” are not intended to define an order, but rather to differentiate between different elements.

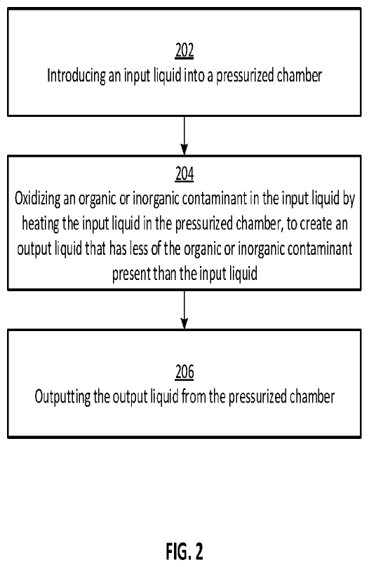

FIG. 2 is a flow chart of an example of a process for removing contaminants from liquids according to some aspects of the present disclosure. While FIG. 2 depicts a certain sequence of steps for illustrative purposes, other examples can involve more steps, fewer steps, different steps, or a different order of the steps depicted in FIG. 2. The steps of FIG. 2 are described below with reference to components of FIG. 1.

In block 202, an input liquid is introduced into a pressurized chamber. An example of the input liquid can be the contaminated liquid 116, and an example of the pressurized chamber can be chamber 106 after it has been pressurized by the pressurizer 110.

In block 204, an organic or inorganic contaminant in the input liquid is oxidized by heating the input liquid in the pressurized chamber. This creates an output liquid 118 that has less of the organic or inorganic contaminant present than the input liquid. For example, the input liquid can be oxidized by heating the input liquid to generate thermal ionization thereof, which in turn can increasing a concentration of hydroxyl radicals in the input liquid. Then, chemical reactions can take place between the hydroxyl radicals and the organic/inorganic contaminant in the input liquid, to thereby oxidize the contaminant. This oxidation can occur without introducing a separate oxidizing agent or catalyst into the pressurized chamber.

The input liquid is at least initially heated using a heating device 108 to initiate the oxidation process. Additional heat can also be generated as a result of the oxidation process. So, a thermal controller can be used to monitor and adjust the temperature of the input liquid, so as to offset the additional heat generated as a result of the oxidation process. This may maintain the temperature of the input liquid within a preset temperature range, such as at a temperature that is less than 374° C.

In block 206, the output liquid 118 is output from the pressurized chamber. This output liquid 118 may be in its final purified state, or may undergo one or more further liquid-treatment processes. For example, the output liquid 118 can be provided as an input to another liquid-treatment process to further purify it. This process can iterate until a desired purity level has been achieved.

### Exemplary Tests

Several example systems were developed to test the efficacy of various techniques described herein in relation to different types of contaminated liquids. Two of these example systems are described below.

One example system was configured to decontaminate textile-production wastewater, such as sludge resulting from polyester dyeing and finishing apparel. In this case, wastewater from the textile dye process was introduced into the system using a steam generator, which was developed by modifying an Easy-Kleen EZN3004 to allow heating of water to 330° C. and pressurization to 3000 psi. External heat was supplied using a heating device comprising a natural-gas fired burner, and the pressurized chamber was comprised of a 316-stainless steel coil. The steam generator was equipped with an AI-assisted thermal controller to monitor and compensate for changes in fuel combustion. The wastewater was pumped through the system using a hydraulic pump and impact nozzles, capable of pumping up to 3 gpm at up to 3000 psi into the chamber. Gaseous emissions output as a byproduct from the system were monitored to ensure complete oxidation of the original contaminants. The resulting output liquid was significantly decontaminated with respect to the input wastewater. The output liquid was then further treated by low pressure air generated by a turbine exhaust airflow, e.g., as described in U.S. Pat. No. 9,751,026 to Mahato.

Another example system was configured to decontaminate hydrocarbon-production water, such as water resulting from producing oil or gas from a wellbore. In this case, the heating device was a Tempco circulation heater (model CHF02339), as modified to incorporate a PID temperature controller allowing heating to 360° C. The fluid system was made from Inconel 600 and 316 stainless steel to provide thermal and corrosion resistance at high pressures. The tests were conducted at Texas A&M University's Global Petroleum Research Institute on its Riverside Campus using oilfield-produced water collected form a partner's saltwater disposal well. The water was pumped through the system using a hydraulic pump and impact nozzles, capable of pumping up to 0.25 gpm at up to 3000 psi into the chamber. The resulting output liquid was significantly decontaminated with respect to the input water. The output liquid was then further treated by low pressure air generated by a turbine exhaust airflow, e.g., as described in U.S. Pat. No. 9,751,026 to Mahato.

### Advantages of Contaminant Removal Examples

There are numerous advantages to the various examples described herein. For instance, removing organic or inorganic contaminants via hydroxyl-radical mediated oxidation may avoid the use of membranes, filters, resins, absorption matrices, and chemical agents, which can be expensive, dangerous, rare, and/or environmentally damaging. This can enable exemplary systems described herein to be built faster and cheaper, in remote locations with limited resources, and with a lower environmental impact, than alternative approaches.

Some examples can also decontaminate liquids without producing a liquid byproduct, such as sludge or brine concentrate. For example, removing organic or inorganic contaminants via hydroxyl-radical mediated oxidation can convert these contaminants into a gaseous state (e.g., CO₂) that can be safely released into the environment. This can avoid the time, expense, challenges, and environmental impacts associated with liquid byproducts.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, examples described herein can be combined together to yield still further examples.

1. A method comprising:
introducing an input liquid into a pressurized chamber;
oxidizing an organic or inorganic contaminant in the input liquid by heating the input liquid in the pressurized chamber, to create an output liquid that has less of the organic or inorganic contaminant than is present in the input liquid; and
outputting the output liquid from the pressurized chamber.

2. The method of claim 1, wherein the input liquid is introduced as a continuous flow into the pressurized chamber at a predefined flow rate over a predefined timespan, and the output liquid is output in another continuous flow from the pressurized chamber over the predefined timespan.

3. The method of claim 2, wherein the predefined flow rate is controlled by a pump or an orifice associated with the pressurized chamber.

4. The method of claim 2, wherein the predefined flow rate is between 1 gallon per minute and 10 gallons per minute.

5. The method of claim 1, wherein the pressurized chamber is pressurized to at least 1500 pounds-per-square-inch (psi).

6. The method of claim 5, wherein the pressurized chamber is pressurized to between 2000 psi and 4000 psi.

7. The method of claim 1, wherein oxidizing the organic or inorganic contaminant in the input liquid comprises:
increasing a concentration of hydroxyl radicals in the input liquid by heating the input liquid; and
oxidizing the organic or inorganic contaminant through a chemical reaction with the hydroxyl radicals in the input liquid.

8. The method of claim 7, wherein the concentration of hydroxyl radicals is increased as a result of thermal ionization of the input liquid in response to the heating of the input liquid.

9. The method of claim 1, wherein the organic or inorganic contaminant is oxidized without introducing a separate oxidizing agent or catalyst into the pressurized chamber.

10. The method of claim 1, wherein the input liquid is heated to oxidize the organic or inorganic contaminant using a heating device.

11. The method of claim 10, wherein the organic or inorganic contaminant is oxidized by heating the input liquid while the input liquid is within the pressurized chamber using only the heating device and/or while the input liquid is in a liquid state.

12. The method of claim 10, further comprising:
receiving, by a thermal controller, a sensor signal from a temperature sensor, the sensor signal indicating a temperature associated with the output liquid; and
adjusting, by the thermal controller, a thermal output of the heating device based on the sensor signal from the temperature sensor.

13. The method of claim 12, wherein the thermal output of the heating device is adjusted to offset additional heat generated as a result of oxidizing the organic or inorganic contaminant, thereby maintaining the temperature within a preset temperature range.

14. The method of claim 12, wherein adjusting the thermal output of the heating device comprises maintaining the temperature at less than 374 degrees Celsius.

15. The method of claim 1, wherein the output liquid is a first output liquid, and further comprising providing the first output liquid as an input to a treatment process in which a particulate contaminant is removed from the first output liquid to generate a second output liquid having less of the particulate contaminant than the first output liquid.

16. The method of claim 15, wherein the treatment process excludes membranes, filters, resins, or absorption matrices.

17. The method of claim 15, wherein the treatment process does not produce a liquid byproduct.

18. The method of claim 1, wherein the input liquid includes textile-production wastewater.

19. The method of claim 1, wherein the input liquid includes hydrocarbon-production wastewater.

20. A system comprising:
a chamber;
a pressurizer coupled to the chamber, the pressurizer being configured to pressurize the chamber to a predefined pressure level; and
a heating device coupled to the chamber, the heating device being configured to apply heat to the chamber;
wherein the system is configured to apply the heat from the heating device to an input liquid in the chamber while the chamber is pressurized to the predefined pressure level, to thereby oxidize an organic or inorganic contaminant in the input liquid and create an output liquid that has less of the organic or inorganic contaminant than is present in the input liquid.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)
